(19) United States
(12) Patent Application Publication
(10) Pub. No.: US 2013/0016262 A1
(43) Pub. Date: Jan. 17, 2013

(54) IMAGER EXPOSURE CONTROL

(71) Applicants: PETER I. MAJEWICZ, Boise, ID (US); JENNIFER L. MELIN, Boise, ID (US)

(72) Inventors: PETER I. MAJEWICZ, Boise, ID (US); JENNIFER L. MELIN, Boise, ID (US)

(21) Appl. No.: 13/183,003

(22) Filed: Jul. 14, 2011

(51) Int. Cl. H04N 5/335

(52) U.S. Cl. 348/302

(57) ABSTRACT

One example discloses a method for producing an image of a scene. An ambient image of the scene illuminated only by ambient light is captured. A percentage of pixels in the calibration image having a digital count greater than a threshold digital count is determined. A first image capture technique is performed if a percentage of pixels in the ambient image having a digital count greater than a threshold digital count is above a threshold percentage. A second image capture technique is performed if the percentage of pixels in the ambient image having a digital count greater than a threshold digital count is not above the threshold percentage.

### BACKGROUND

Digital imaging is the creation of digital images, typically from a physical scene. Digital imagers can include an array of light sensitive sensors to capture the image focused by the lens, as opposed to an exposure on light sensitive film. The captured image can be stored as a digital file ready for digital processing (e.g., color correction, sizing, cropping, etc.), viewing or printing.

### BRIEF DESCRIPTION OF THE DRAWINGS

FIG. 1 illustrates an example of an imager.

FIG. 2 illustrates an example of a methodology for capturing an image of a scene.

FIG. 3 illustrates another example methodology for the capture of an image of a scene at an imager.

FIG. 4 illustrates an example of a methodology for the capture of an image of a scene at an imager in high ambient illumination conditions.

FIG. 5 illustrates an example of a method for determining if the imager system should remain in a high ambient illumination mode.

FIG. 6 illustrates one example of a methodology for calibrating an imager system.

### DETAILED DESCRIPTION

One example of a digital imager system can utilize a multiple-mode exposure account for variability of ambient lighting conditions. For example, a first integration time for the system can be used where ambient illumination is insufficiently intense to interfere with the imaging of a flash lamp illuminated scene, and a second integration time can be used where the ambient illumination is determined to be sufficient to induce errors within the imaged content. It will be appreciated that the term “scene,” as used herein is intended to refer generally to everything within the field of view of a camera at the time an image is captured. The digital imager system can use an image of the scene, taken in ambient lighting conditions, both for a determination of the intensity of the ambient lighting as well as to determine an appropriate correction to the flash lamp illuminated imaged content to mitigate the effects of the ambient lighting.

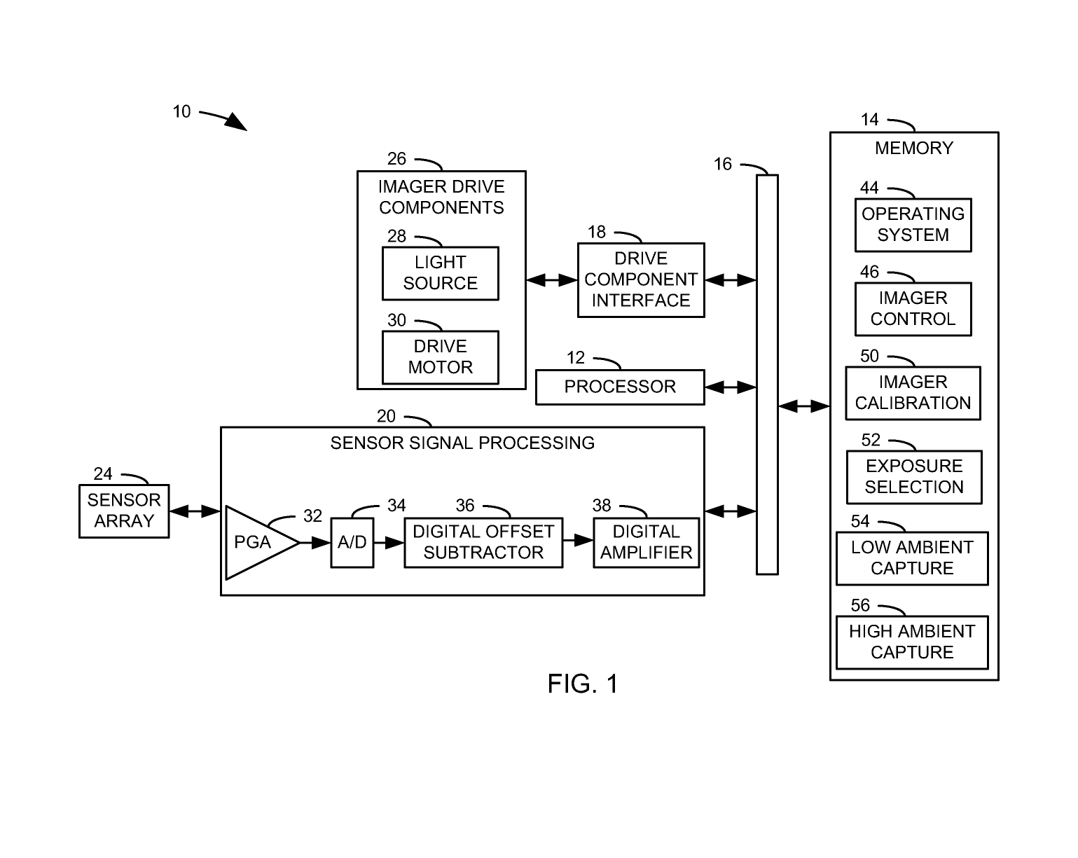

FIG. 1 illustrates an example of an imager 10. The imager 10 includes a processor 12 and a memory 14, each coupled to a local interface 16. For example, the local interface 16 can include a data bus with an accompanying control bus. The memory 14 can include both volatile and nonvolatile memory components. Volatile components are those that do not retain data values upon loss of power. Nonvolatile components are those that retain data upon a loss of power. Thus, the memory 14 can include random access memory (RAM), read-only memory (ROM), hard disk drives, floppy disks accessed via an associated floppy disk drive, optical media accessed via an optical drive, magnetic tapes accessed via an appropriate tape drive, and/or other memory components, or a combination of any two or more of these memory components. In addition, the processor 12 can represent multiple processors and the memory 14 can represent multiple memories that operate in parallel. In such a case, the local interface 16 may be an appropriate network that facilitates communication between any two of the multiple processors or between any processor and any of the memories. The local interface 16 can facilitate memory to memory communication in addition to communication between the memory 14 and the processor 12.

The imager 10 further includes a drive component interface 18 and a sensor signal processing interface 20, each coupled to the local interface, and a sensor array 24 that is coupled to the local interface 16 through the sensor signal processing interface 20. The sensor array 24 includes a plurality of sensors, which can be arranged in a row, for example, to enable the scanning of lines in a document as it progresses past the sensor array 24, a two-dimensional array, or any other appropriate configuration for scanning a desired region. The plurality of sensors comprising the sensor array 24 can include, for example, active pixel sensors (e.g., complementary metal-oxide-semiconductor [CMOS] sensors) or charge coupled device (CCD) sensors. In one example, the position of the sensor array 24 can be fixed, such that a specific imaging region is defined by the arrangement and position of the sensor array.

The imager can further include a set of imager drive components 26 coupled to the local interface 16 through the drive component interface 18. The imager drive components 26 can include any components employed in the general operation of an imaging system 10. For example, the drive components can include a light source 28 for illuminating at least a portion of the imaging region defined by the position and arrangement of the sensor array. In one implementation, the light source 28 can include a light emitting diode (LED) configured to produce white light. In another implementation, the light source 28 can include light sources of various colors and frequency bands. For example, the light source 28 can include any or all of red, green, blue, and infrared LEDs that generate light that is distributed across the imaging region with a light pipe. In one example, the imager drive components 26 can also include a drive motor 30 to translate a paper document or other media past the sensor array 24.

The sensor signal processing interface 20 includes sensor signal processing circuitry to processes signals produced by the sensors in the sensor array 24 during the course of a scanning operation. In the illustrated example, the sensor signal processing interface 20 includes a programmable gain amplifier 32 that receives a sensor signal from a sensor in the sensor array 24 and applies an analog gain to the sensor signal. The sensor signal is then provided to an analog-to-digital (A/D) converter 34 to convert the amplified sensor signal into a digital signal value. The digital sensor value is then provided to a digital offset subtractor 36 that subtracts a digital offset, referred to herein as a “dark offset,” from the digital value. The sensor value is then provided to a digital amplifier 38 that amplifies the sensor value by an associated digital gain to provide a digital count for the sensor. In the illustrated implementation, data associated with each color channel is subjected to a digital gain selected for the color channel, such that the digital gain applied to the output of a given sensor value depends on the color channel represented by the signal. The digital gain for each color channel, the digital offset, and the analog gain can all be determined by an associated calibration process, described in detail below, and stored in the memory 14 for use in processing the sensor signal. The resulting digital count can be provided to appropriate buffer circuitry and/or other circuitry (not shown) to be accessed by the processor 12 through the local interface 16.

The imager 10 includes various components that are stored within the memory 16 and executable by the processor 12 for performing the functionality of the imager 10. In particular, stored on the memory 16 are an operating system 44, an imager control 46, imager calibration logic 50, and exposure selection logic 52. The operating system 44 is executed to control the allocation and usage of hardware resources in the imager. For example, the operating system 44 can control the allocation and usage of the memory 16. The imager control 46 is executed by the processor 12 to control the general operation of the imager 10. In particular, the imager control system 46 can control the activation of the light source 28, the drive motor 30, and any other subsystems of the imager 10. The imager calibration logic 50 is executed by the processor 12 to calibrate the imager, including acquiring an integration time, the dark offset, and the analog and digital gains for the imager. In one example, the calibration logic 50 determines initial exposure settings for the device based on an image of a white target, although it will be appreciated that any of a number of calibration processes can be used. The calibration logic can be performed when the imager is manufactured, by the user before or during use of the device, depending on the implementation.

The exposure selection logic 52 evaluates an image taking using the ambient illumination and selects, from the ambient image, either low ambient illumination capture logic 54 or high ambient illumination capture logic 56 for use at the sensor array 24 to capture an image of the scene. For example, the exposure selection logic 52 can select the high ambient illumination capture logic 56 if a percentage of pixels in the calibration image having a digital count greater than a threshold digital count exceeds a threshold percentage and select the low ambient capture logic if the percentage of pixels in the calibration image having a digital count greater than a threshold digital count does not exceed the threshold percentage.

The low ambient illumination capture logic 54 instructs the imager control 46 to capture an illuminated image of the scene illuminated by both ambient illumination and the light source 28 and subtracts a digital count of each pixel in the ambient image from a digital count associated with a corresponding pixel in the illuminated image. The high ambient illumination capture logic 56 can iteratively reducing an integration time, digital gain, or analog gain associated with the imager until a representative digital count associated with the ambient image falls below a threshold. From this reduced integration a flux value representing the intensity of the ambient illumination can be determined. First and second integration times can be determined from the flux value, and the imager control 46 can be instructed to capture with a first image with ambient illumination using the first integration time and capturing a second image, with illumination from the light source, at the second integration time. A digital count of each pixel in the first image can be subtracted from a digital count associated with a corresponding pixel in the second image to produce an ambient corrected image.

The exposure selection 52 utilized in the illustrated system 10 allows for the sensor array 24 and the light source 28 to operate in a wide range of ambient light conditions and achieve correct exposure throughout the range. As such, the digital counts returned by the sensor array 24 and the sensor signal processing interface 20 can be constrained to a smaller range, allowing for economy of hardware and memory in obtaining and storing the digital count values. For example, in one implementation, each pixel in the captured image can be represented by an eight-bit value, as the exposure selection 52 avoids the misuse of the available range of digital counts on under-exposed or over-exposed illumination levels. It has been determined that a range of at least one hundred digital counts are desirable for representing variations in the scene content. For an eight-bit system, those one hundred digital counts represent around forty percent of the available dynamic range, leaving a minimal buffer around the scene data for the illumination and dark offset. The exposure selection 52 facilitates the operation of the system with this minimal buffer.

The illustrated system 10 also functions without an ambient light sensor independent of the sensor array 24. The sensor array 24 is used to sample the scene and select coarse exposure settings, reducing the necessary hardware. The light source 28 is activated only during scene capture and not for the exposure selection. While this prevents a direct analysis of the scene as it will be illuminated in the final image, it eliminates extraneous flashes that might be an annoyance to a user and avoids overuse of the light source 28, which can lead to burn-out or output droop. The system is also suitable for imaging macroscopic content, and the exposure selection 52 can be adapted for such content. The system is can also be used in situations where the user can directly compare the original scene to the image, for example, in document scanning or copying operations.

FIG. 2 illustrates an example methodology 100 for producing an image of a scene. At 102, an image of the scene is captured at ambient illumination, that is, without activating a light source associated with the imager. This image is referred to herein as an “ambient image.” It will be appreciated that associated calibration parameters stored at the imager, including integration time, analog and digital gains, and dark offset, can be used in capturing the ambient image. At 104, it is determined if a percentage of pixels in the ambient image having a digital count greater than a threshold digital count exceed a threshold percentage. For example, a cumulative histogram can be generated representing a distribution of digital counts associated with the individual pixels of the ambient image, and a digital count corresponding to a target percentile, representing the threshold percentage, can be selected. If the digital count is less than the threshold digital count, the percentage of pixels above the threshold digital count is less than the threshold percentage.

If it is determined that the percentage of pixels above the threshold digital count fails to exceed the threshold percentage, an image capture technique for low ambient illumination conditions is performed at 106. This can include a subtraction of the ambient image from an illuminated image, such that the final, ambient corrected image is generated by subtracting a digital count of each pixel in the ambient image from a digital count associated with a corresponding pixel in the illuminated image. If it is determined that the percentage of pixels above the threshold digital count exceeds the threshold percentage, an image capture technique for high ambient illumination conditions is performed at 108.

For example, the image capture technique for high ambient illumination can include iteratively reducing one of an integration time, a digital gain, and an analog gain associated with the imager until a representative digital count associated with the ambient image falls below a threshold. In one example, a flux value representing the intensity of the ambient illumination can be calculated from the reduced integration time or gain. From the calculated flux value, integration times for another ambient image and an illuminated image can be calculated. A first image with ambient illumination can be taken using the ambient integration time, and an illuminated image with illumination from the light source can be taken at the illuminated integration time. A digital count of each pixel in the ambient image can be subtracted from a digital count associated with a corresponding pixel in the illuminated image to provide a final, ambient corrected image.

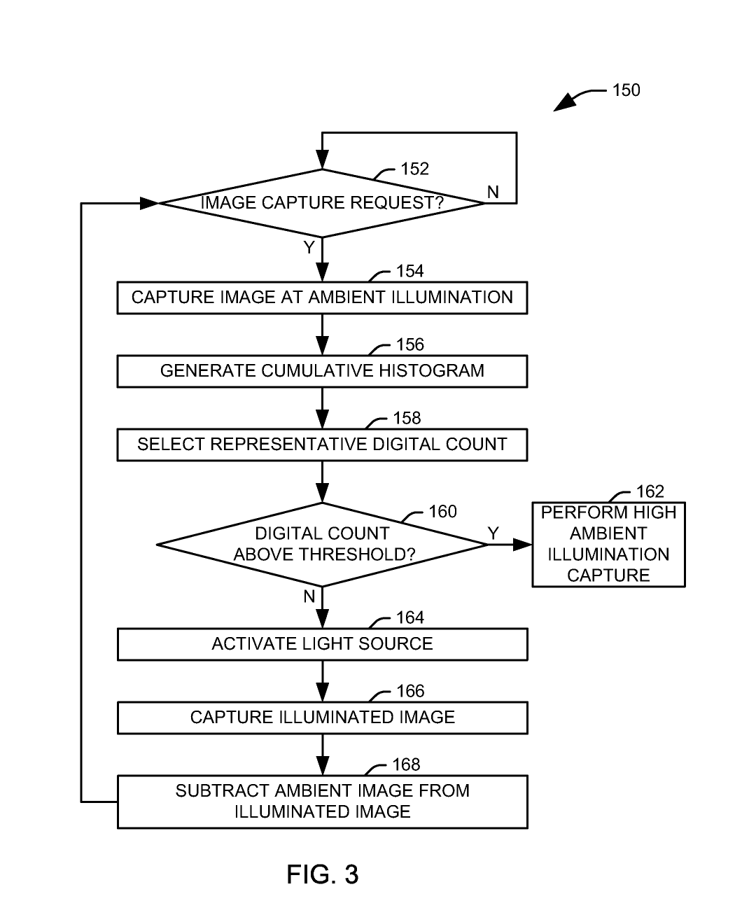

FIG. 3 illustrates an example methodology 150 for the capture of an image of a scene at an imager. At 152, the imager waits for a capture request. When a capture request is received, an image of the scene is captured at ambient illumination at 154. It will be appreciated that associated calibration parameters stored at the imager, including integration time, analog and digital gains, and dark offset, can be used in capturing the ambient image. At 156, a cumulative histogram can be generated of the digital counts of all pixels of the ambient image. In one implementation, cumulative histograms are created for the digital counts for each color channel within the ambient image. It will be appreciated that the cumulative histogram can represent the entire ambient image or a selected portion of the image. At 158, a representative digital count is selected for the ambient image. For example, a digital count associated with a predetermined target percentile in the cumulative histogram can be selected as a representative count. In one example, the target percentile is the ninety-fifth percentile. Where multiple cumulative histograms were generated at 156, a representative digital count can be selected for each color channel, with the largest of these digital counts can be selected to represent the ambient image.

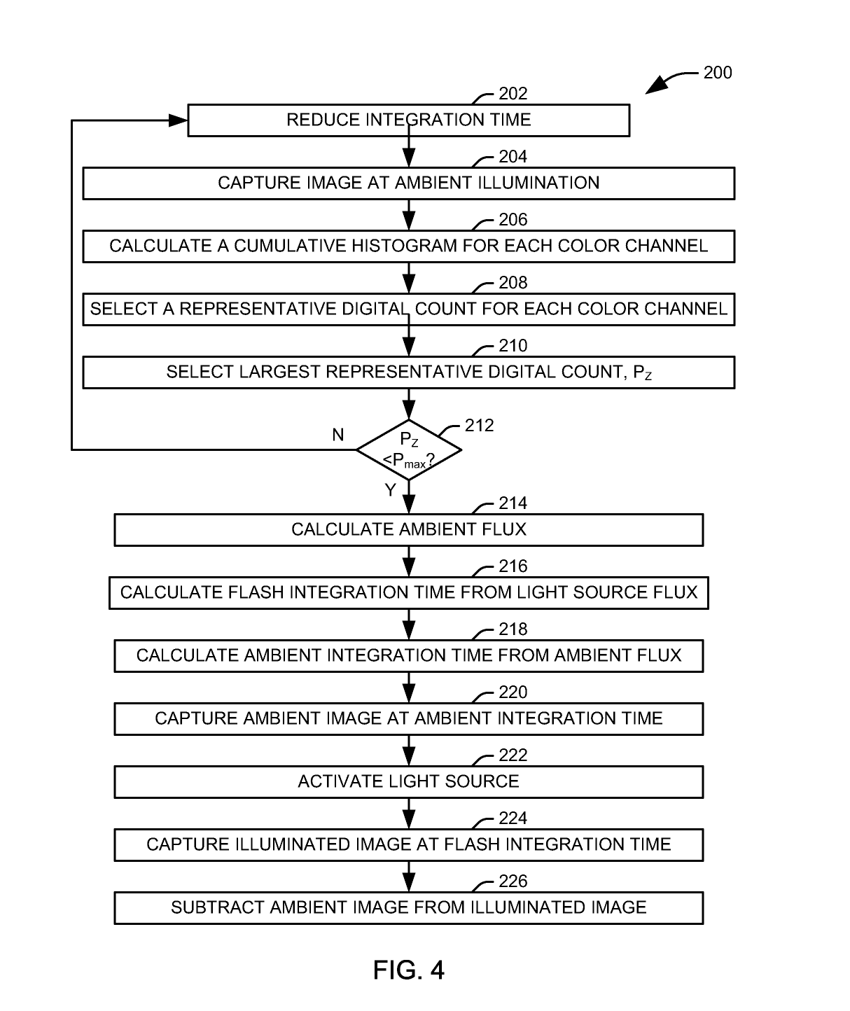

At 160, it is determined if the representative digital count exceeds the threshold. If so (Y), the methodology advances to 162, where an image capture procedure designed for high ambient illumination conditions is performed. One example of such a procedure is provided herein as FIG. 4. Where the representative digital count does not exceed the threshold (N), an image capture procedure designed for low ambient illumination conditions is performed. To this end, at 164, the light source is activated for a short time to illuminate the target, and the camera captures an illuminated image while the light source is activated at 166. At 168, a pixel-by-pixel subtraction of the ambient image from the illuminated image is performed to produce an ambient light corrected image. For example, a digital count of each pixel in the ambient image can be subtracted from the digital count of a corresponding pixel in the illuminated image. The methodology then returns to 152 to wait for a new capture request.

FIG. 4 illustrates an example of a methodology 200 for the capture of an image of a scene at an imager in high ambient illumination conditions. At the start of the methodology, a set of calibration parameters is specified. These include but are not limited to integration time, I_{C}, a set of digital gains, D_{R}, D_{G}, D_{B}, for the plurality of color channels, an analog gain, A, and a dark offset, P_{OFF}. At 202, the integration time is reduced. In one implementation, a new integration time, I_{NOSAT}, can be generated by dividing the integration time, I_{INT}, by a predetermined scaling factor, d. In one implementation, the constant value is equal to two, such that the integration time is halved.

At 204, an image is captured using only ambient illumination using the reduced integration time. At 206, cumulative histograms are created for the digital counts for each color channel within the ambient image. It will be appreciated that the cumulative histogram can represent the entire image or a selected portion of the image. At 208, a representative digital count is selected for each color channel. For example, a digital count associated with a predetermined target percentile in the cumulative histogram can be selected as a representative count. In one example, the target percentile is the ninety-ninth percentile. At 210, a largest of the representative digital counts, P_{Z}, is selected to represent the ambient image.

At 212, it is determined if the selected representative digital count for the ambient image is less than an associated threshold digital count, P_{MAX}. The threshold digital count can represent a maximum portion of the available range of digital counts allocated to accommodating ambient lighting conditions. If not (N), it is determined that the illuminated image would contain an undesirable number of saturated pixels, and the methodology returns to 202 to further reduce the integration time. For example, the integration time, I_{NOSAT}, can be divided again by the predetermined scaling factor to produce a new integration time, I_{NOSAT}=I_{NOSAT}/d. If the selected representative digital count for the ambient image is less than the threshold digital count (Y), it is determined that the effects of the ambient illumination are within acceptable boundaries, and the methodology advances to 214.

At 214, an ambient flux value is calculated from the reduced integration time, I_{NOSAT}. In the illustrated example, the ambient flux, Φ_{AMB}, is a unitless parameter representing the current ambient light level, and is calculated as:

$${Φ}_{AMB} = ( \frac{{P}_{Y} - {P}_{OFF}}{{P}_{MAX} - {P}_{OFF}} ) ( \frac{{I}_{MAX}}{{I}_{NOSAT}} ) ( \frac{1}{A} ) ( \frac{1}{{D}_{Y}} ) \qquad Eq . 1$$

where P_{Y} is the representative digital count of the color channel having a smallest associated digital gain D_{Y}, and I_{MAX} is a preselected integration time for the imager. In one implementation, I_{MAX} represents a longest possible integration time for the imager.

At 216, a flash integration time is calculated from a light source flux, Φ_{LS}. The light source flux is a unitless parameter representing the illumination provided by the light source. The light source flux can be precalculated from the calibration parameters of the system as:

$${Φ}_{LS} = ( \frac{{P}_{TARGET} - {P}_{OFF}}{{P}_{MAX} - {P}_{OFF}} ) ( \frac{{I}_{MAX}}{{I}_{CAL}} ) ( \frac{1}{A} ) ( \frac{1}{{D}_{Y}} ) \qquad Eq . 2$$

where P_{TARGET} is a digital count value representing a portion of the available range of digital counts allocated to representing the content of the imaged scene.

From this light source flux and the ambient flux, an integration time, I_{ILL}, for the illuminated image frame can be determined as:

$${I}_{ILL} = ( \frac{{P}_{TARGET} - {P}_{OFF}}{{P}_{MAX} - {P}_{OFF}} ) ( \frac{{I}_{MAX}}{1} ) ( \frac{1}{A} ) ( \frac{1}{{D}_{Y}} ) ( \frac{1}{{Φ}_{AMB} + {Φ}_{LS}} ) \qquad Eq . 3$$

which reduces to:

$${I}_{ILL} = {I}_{CAL} ( \frac{{Φ}_{LS}}{{Φ}_{AMB} + {Φ}_{LS}} ) \qquad Eq . 4$$

At 218, an ambient integration time, I_{AMB}, is calculated from the ambient flux and the calibration parameters, such that:

$${I}_{AMB} = {I}_{MAX} ( \frac{{P}_{AMBIENT} - {P}_{OFF}}{{P}_{MAX} - {P}_{OFF}} ) ( \frac{1}{A} ) ( \frac{1}{{D}_{Y}} ) ( \frac{1}{{Φ}_{AMB}} ) \qquad Eq . 5$$

where P_{AMBIENT} is a digital count value representing a portion of the available range of digital counts allocated to representing the effects of the ambient illumination.

At 220, an image is captured using only ambient illumination using the calculated ambient integration time. At 222, the light source is activated for a short time to illuminate the target, and the camera captures an illuminated image, using the flash integration time, while the light source is activated at 224. At 226, a pixel-by-pixel subtraction of the ambient image from the illuminated image is performed to produce an ambient light corrected image. For example, a digital count of each pixel in the ambient image can be subtracted from the digital count of a corresponding pixel in the illuminated image.

It will be appreciated that the methodology of FIG. 4 represents the operation of the imager in a high ambient illumination mode configured to accommodate situations in which the ambient illumination is sufficient to, in combination with the light source, cause saturation of a significant number of pixels in the illuminated image. To this end, upon receiving a new capture request, the system can make a determination as to whether the imager should remain in the high ambient illumination mode or revert to the standard, low ambient illumination mode. In one example, the imager can repeat the functions described in FIG. 3 as 152, 154, 156, 158, and 160 to determine an appropriate mode for each capture request. To avoid repeated switching between modes, the target percentile used to select a representative digital count for the image can be reduced (e.g., to the ninetieth percentile) when the imager is in the high ambient illumination mode,

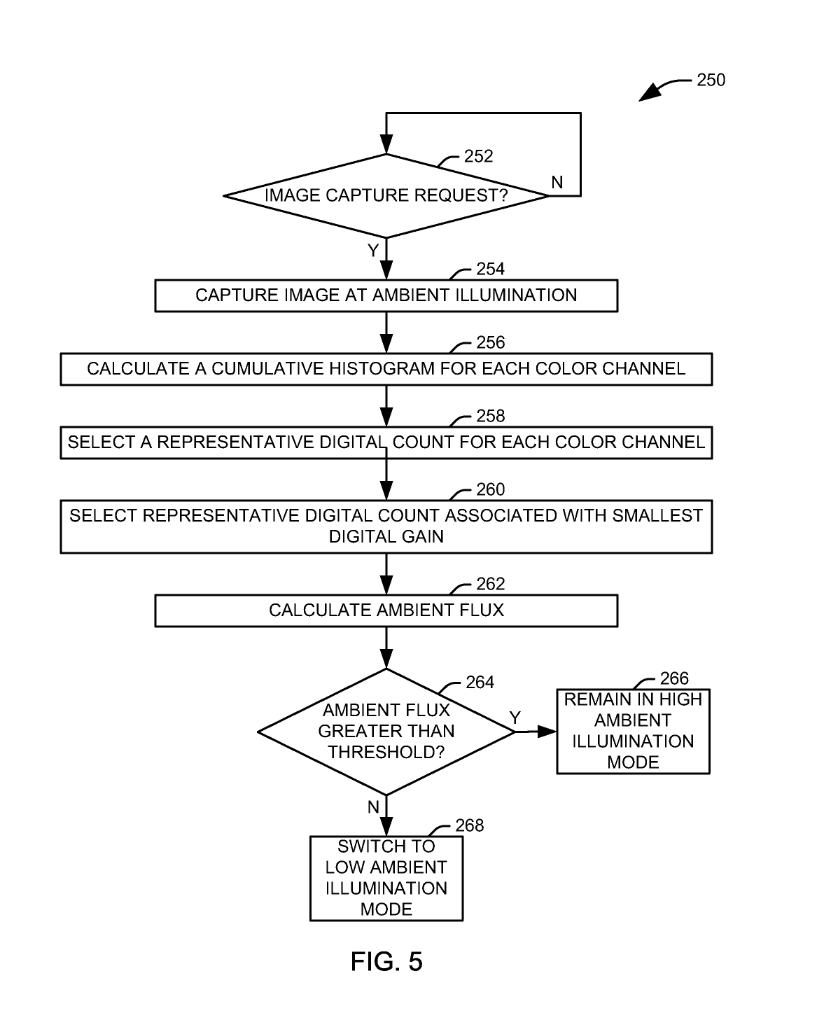

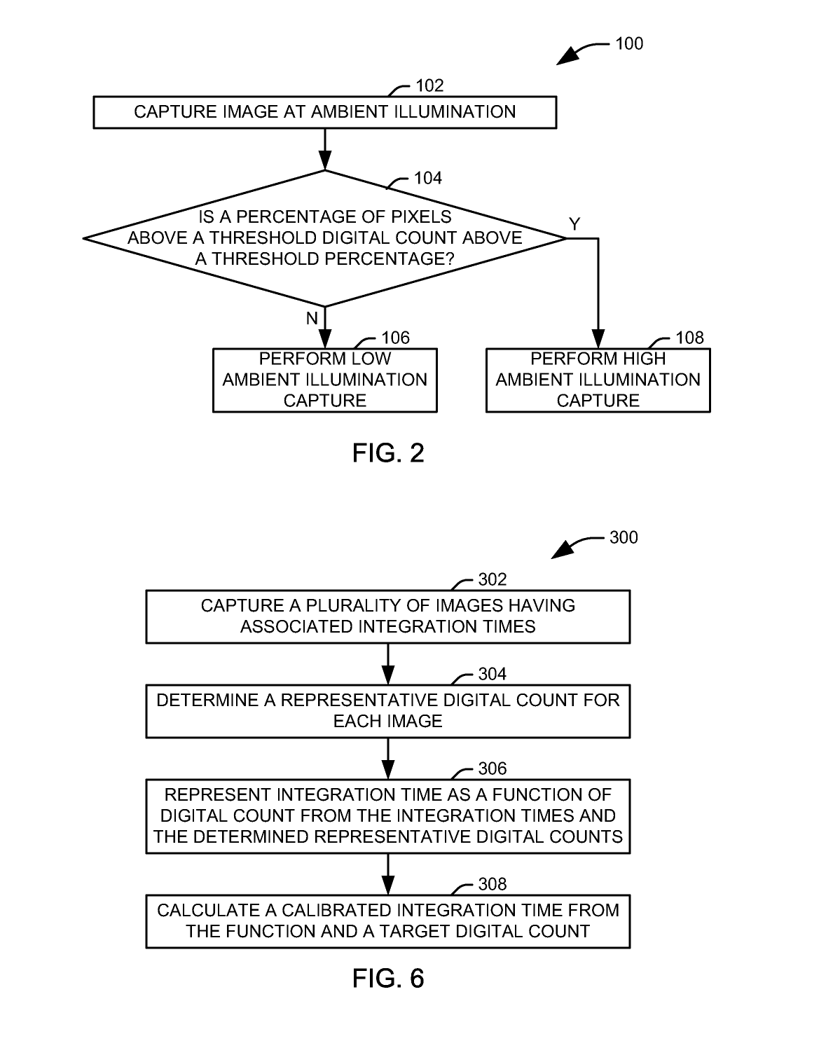

Another example of a methodology 250 for determining if the imaging system should remain in the high ambient illumination mode can be found in FIG. 5. At 252, the imager waits for a capture request. When a capture request is received, an image of the scene is captured at ambient illumination, that is, without activating a light source associated with the imager, at 254. It will be appreciated that associated calibration parameters stored at the imager, including integration time, analog and digital gains, and dark offset, can be used in capturing the ambient image. In other words, for the purposes of this determination, any integration times or gains calculated during a preceding high ambient illumination capture can be discarded.

At 256, cumulative histograms are created for the digital counts for each color channel within the ambient image. It will be appreciated that the cumulative histogram can represent the entire image or a selected portion of the image. At 258, a representative digital count is selected for each color channel. For example, a digital count associated with a predetermined target percentile in the cumulative histogram can be selected as a representative count. In one example, the target percentile is the ninety-ninth percentile. At 260, a representative digital count, P_{Y}, of the color channel having a smallest associated digital gain, D_{Y}, is selected as a representative digital count for the ambient image.

At 262, an ambient flux, Φ_{AMB}, is calculated from the representative digital count for the ambient image as:

$${Φ}_{AMB} = ( \frac{{P}_{Y} - {P}_{OFF}}{{P}_{MAX} - {P}_{OFF}} ) ( \frac{{I}_{MAX}}{{I}_{Y}} ) ( \frac{1}{A} ) ( \frac{1}{{D}_{Y}} ) \qquad Eq . 6$$

The calculated ambient flux is compared to a threshold flux value, Φ_{SUMAMB}, at 264. Where the ambient flux is greater than the threshold flux (Y), the methodology advances to 266, where the imager remains in the high ambient illumination mode, such that the requested image capture is performed with an ambient correction suitable for high ambient light conditions (e.g., the methodology of FIG. 4). Where the ambient flux is not greater than the threshold flux (N), the methodology advances to 268, where the imager switches to the low ambient illumination mode, and the requested image capture is performed with an ambient correction suitable for high ambient light conditions, such as the ambient background subtraction of FIG. 3. The threshold flux value can represent a tolerable level of ambient light for the low ambient illumination capture, determined as:

$${Φ}_{SUBAMB} = ( \frac{{P}_{AMBIENT} - {P}_{OFF}}{{P}_{MAX} - {P}_{OFF}} ) ( \frac{{I}_{MAX}}{{I}_{Y}} ) ( \frac{1}{A} ) ( \frac{1}{{D}_{Y}} ) \qquad Eq . 7$$

In one implementation, a hysteresis value, Φ_{HYST}, can be calculated as 0.05*Φ_{LS}, where Φ_{LS} is a light source flux calculated in the last high ambient illumination mode capture. The hysteresis value can be subtracted from the threshold flux value prior to the comparison at 264 to stabilize the switching between the two modes when the ambient light is near the threshold level.

FIG. 6 illustrates one example of a methodology 300 for calibrating an imager system. It will be appreciated that this calibration can be performed at the factory, but in some implementations, it can be repeated when desired by a user. At 302, a plurality of images are captured at the imager using an associated light source, with each of the captured images having an associated integration time. For example, each of the images can be taken of a white target, with each image having one of a series of preselected integration times. In one example, a first image of the plurality of images is generated using a shortest possible integration time to allow for determination of a dark offset.

At 304, a representative digital count is determined for each of the plurality of images. In one example, the representative digital count is selected as a minimum value that is brighter than a predetermined percent of pixels within the image, for example, by calculating a cumulative histogram for each image and selecting a digital count corresponding to a target percentile. It will be appreciated that the representative digital count can be determined from analysis of the image as a whole or from analysis of a representative portion of the image. Further, a different representative digital count can be selected for each color channel within the image. At 306, a function relating integration time to digital count is determined from the determined representative digital counts and the integration times associated with the plurality of images. Where data is available for each color channel, a separate function can be determined for each color channel. In one example, images having representative digital count values exceeding a threshold value can be excluded from this process. In addition, the various digital count values can be normalized for this analysis by subtracting a determined dark offset from each value.

In one implementation, the function relating integration time to digital count is determined by representing digital count as a function of integration time from the respective digital counts and integration times associated with the plurality of images and determining an inverse function of the function representing digital count as a function of integration time. To this end, a least squares regression can be conducted on the respective digital counts and integration times associated with the plurality of images to define a second order polynomial function representing digital count as a function of integration time. A derivative of the second order polynomial function can be determined at a predetermined value for integration time, and the function representing digital count as a function of integration time can be determined as a linear function of integration time having a slope equal to the value of the derivative and an intercept parameter equal to an intercept of the second order polynomial function.

At 308, a calibrated integration time is calculated from the determined function and a target digital count. For example, the target digital count can simply be substituted into the determined function to provide the calibrated integration time. Where a function has been generated for each color channel, each function can be evaluated at an associated target digital count to produce its own integration time, with a minimal integration time from the color channels selected as the calibrated integration time. The calculated integration time can also be adjusted downward to a multiple of a flicker period associated with the light source to mitigate distortion due to flickering of the light source during illuminated imaging. In one example, the calibrated integration time can be used to calculate an analog gain for the device as well as individual digital gains for each color channel.

Where the disclosure or claims recite “a,” “an,” “a first,” or “another” element, or the equivalent thereof, it should be interpreted to include one or more than one such element, neither requiring nor excluding two or more such elements. Furthermore, it will be understood that successively described examples are not mutually exclusive unless specific stated to be so. It will also be appreciated that when a functional component is described as stored on a computer readable medium, it can be stored on a single medium or a set of media, each operably connected to another medium in the set or an associated processing unit. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims.

What is claimed is:

1. A method for producing an image of a scene at an imager comprising:
capturing an ambient image of the scene illuminated only by ambient light at a sensor array associated with the imager;
determining if a percentage of pixels in the ambient image having a digital count greater than a threshold digital count exceeds a threshold percentage;
performing a first image capture technique if a percentage of pixels in the ambient image having a digital count greater than a threshold digital count is above a threshold percentage; and
performing a second image capture technique if the percentage of pixels in the ambient image having a digital count greater than the threshold digital count is not above the threshold percentage.

2. The method of claim 1, wherein determining if the percentage of pixels in the ambient image having a digital count greater than the threshold digital count exceeds a threshold percentage comprises calculating a cumulative histogram representing digital counts associated with pixels comprising for the calibration image and selecting a representative digital count corresponding to a target percentile.

3. The method of claim 1, wherein performing the second image capture technique comprises capturing an illuminated image of the scene illuminated by ambient light and a light source associated with the imager and subtracting from a digital count of each pixel in the illuminated image, a digital count associated with a corresponding pixel in the ambient image.

4. The method of claim 1, wherein performing the first image capture technique comprises iteratively reducing an integration time associated with the imager until a representative digital count associated with the ambient image falls below a threshold.

5. The method of claim 4, further comprising calculating a flux value representing the intensity of the ambient illumination from the reduced integration time.

6. The method of claim 5, further comprising:
calculating first and second integration times from the flux value;
capturing a first image with ambient illumination using the first integration time;
capturing a second image with illumination from the light source at the second integration time; and
subtracting from a digital count of each pixel in the second image, a digital count associated with a corresponding pixel in the first image.

6. The method of claim 1, wherein performing the first image capture technique comprises iteratively reducing a digital gain associated with the imager until a representative digital count associated with the ambient image falls below a threshold.

7. The method of claim 1, further comprising determining, in response to a capture request after applying the first ambient light correction, whether to capture the image with the second image capture technique.

8. The method of claim 7, wherein determining whether to capture the image with the second image capture technique comprises:
capturing a first image at ambient illumination;
calculating a flux value associated with the first image; and
capturing the image with the second image capture technique if the flux value meets a threshold flux value.

9. An imager system comprising:
a sensor array;
a processor; and
a memory storing executable instructions comprising:
an imager control to instruct the sensor array to capture an ambient image of a scene illuminated only by ambient illumination at a calibrated integration time; and
exposure selection logic to evaluate the ambient image and select, from the evaluation of the ambient image, either low ambient illumination capture logic or high ambient illumination capture logic for use at the sensor array to capture an image of the scene.

10. The imager system of claim 9, the low ambient illumination capture logic capturing an illuminated image of the scene illuminated by ambient illumination and a light source associated with the imager and subtracting from a digital count of each pixel in the illuminated image, a digital count associated with a corresponding pixel in the ambient image.

11. The imager system of claim 9, wherein the exposure logic evaluating the ambient image comprises selecting the high ambient illumination capture logic if a percentage of pixels in the calibration image having a digital count greater than a threshold digital count exceeds a threshold percentage.

12. The imager system of claim 9, the high ambient illumination capture logic iteratively reducing an integration time associated with the imager until a representative digital count associated with the ambient image falls below a threshold.

13. The imager system of claim 12, the high ambient illumination capture logic calculating a flux value representing the intensity of the ambient illumination from the reduced integration time.

14. The imager system of claim 13, the high ambient illumination capture logic calculating first and second integration times from the flux value, capturing a first image with ambient illumination using the first integration time, capturing a second image with illumination from the light source at the second integration time, and subtracting from a digital count of each pixel in the second image, a digital count associated with a corresponding pixel in the first image.

15. An imager system comprising:
a sensor array;
a processor; and
a memory storing executable instructions comprising:
an imager control to instruct the sensor array to capture an ambient image of a scene illuminated only by ambient illumination at a calibrated integration time; and
exposure selection logic to evaluate the ambient image, reduce an integration time or gain associated with the imager if a percentage of pixels in the ambient image having a digital count greater than a threshold digital count exceeds a threshold percentage, and, if the percentage of pixels in the ambient image having a digital count greater than a threshold digital count does not exceed the threshold percentage, instruct an imager control to capture an illuminated image of the scene illuminated by ambient light and a light source associated with the imager and subtract from a digital count of each pixel in the illuminated image, a digital count associated with a corresponding pixel in the ambient image.
